(19) United States
(12) Patent Application Publication
(10) Pub. No.: US 2022/0410926 A1
(43) Pub. Date: Dec. 29, 2022

(54) Techniques for Navigation Using Spread-Spectrum Signals

(71) Applicant: Microsoft Technology Licensing, LLC, Redmond, WA (US)

(72) Inventors: Amer Aref HASSAN, Kirkland, WA (US); Roy KUNTZ, Kirkland, WA (US)

(73) Assignee: Microsoft Technology Licensing, LLC, Redmond, WA (US)

(21) Appl. No.: 17/360,773

(22) Filed: Jun. 28, 2021

(51) Int. Cl. B60W 60/00; G01S 5/10

(52) U.S. Cl. CPC B60W 60/001; G01S 5/10; B60W 2552/53; B60W 2556/50; B60W 2420/52

(57) ABSTRACT

A data processing system for navigation using-spread spectrum signals herein implements causing a transceiver of the data processing system to transmit a first electromagnetic signal; receiving, via the transceiver, second electromagnetic signals associated with a first object responsive to the first electromagnetic signal, the second electromagnetic signals including first spread-spectrum signals and an identification of the first object incorporated into the first spread-spectrum signals, each respective second electromagnetic signal of the second electromagnetic signals being transmitted from a separate location on the first object; analyzing the second electromagnetic signals to obtain the identification of the first object; and determining a first estimated location of the data processing system relative to the first object by calculating a difference between the time of transmission of the first electromagnetic signal and a respective time of receipt of each of the second electromagnetic signals.

### BACKGROUND

Recent improvements in autonomous and semi-autonomous vehicle technologies have resulted in advances in vehicles that are capable of sensing the environment around the vehicle and navigating the vehicle safely through the environment with little or no human input. Many autonomous and semi-autonomous vehicles rely on image analysis technology to analyze video and/or images of the environment captured by cameras mounted on the vehicle to obtain information about the environment surrounding the vehicle. Many autonomous and semi-autonomous vehicles rely on LiDAR systems that scan the local environment using lasers and analyze reflected laser light to generate a representation of the environment surrounding the vehicle. However, these approaches have significant drawbacks. Both image analysis and LiDAR techniques may be adversely affected by adverse weather conditions. Rain, snow, smoke, and fog may make image analysis difficult by obscuring details of the environment around the vehicle. Furthermore, the lasers used by the LiDAR systems may be scattered in such conditions. Image and/or video analysis techniques are also impacted by ambient lighting conditions. At night, such systems may rely on vehicle headlights to illuminate the environment surrounding the vehicle. However, vehicle headlights typically illuminate only a very limited area in front of the vehicle, which may severely limit the effectiveness of the image processing navigation systems. Hence, there is a need for improved systems and methods for obtaining information about the environment around autonomous or semi-autonomous vehicles.

### SUMMARY

An example data processing system according to the disclosure may include an antenna, a transceiver coupled to the antenna and configured to send and receive electromagnetic signals via the antenna, and a controller communicably coupled with the transceiver. The controller includes a processor and a computer-readable medium storing executable instructions. The instructions when executed, cause the system to perform operations including causing the transceiver to transmit a first electromagnetic signal; receiving, via the transceiver, second electromagnetic signals associated with a first object responsive to the first electromagnetic signal, the second electromagnetic signals including first spread-spectrum signals and an identification of the first object, each respective second electromagnetic signal of the second electromagnetic signals being transmitted from a separate location on the first object; analyzing the second electromagnetic signals to obtain the identification of the first object; and determining a first estimated location of the data processing system relative to the first object by calculating a difference between the time of transmission of the first electromagnetic signal and a respective time of receipt of each of the second electromagnetic signals.

An example method implemented in a data processing system includes causing a transceiver associated with the data processing system to transmit a first electromagnetic signal; receiving, via the transceiver, second electromagnetic signals associated with a first object responsive to the first electromagnetic signal, the second electromagnetic signals including first spread-spectrum signals and an identification of the first object, each respective second electromagnetic signal of the second electromagnetic signals being transmitted from a separate location on the first object; analyzing the second electromagnetic signals to obtain the identification of the first object; and determining a first estimated location of the data processing system relative to the first object by calculating a difference between the time of transmission of the first electromagnetic signal and a respective time of receipt of each of the second electromagnetic signals.

An example computer-readable storage medium according to the disclosure on which are stored instructions which when executed cause a processor of a programmable device to perform operations of: causing a transceiver associated with the data processing system to transmit a first electromagnetic signal; receiving, via the transceiver, second electromagnetic signals associated with a first object responsive to the first electromagnetic signal, the second electromagnetic signals including first spread-spectrum signals and an identification of the first object, each respective second electromagnetic signal of the second electromagnetic signals being transmitted from a separate location on the first object; analyzing the second electromagnetic signals to obtain the identification of the first object; and determining a first estimated location of the data processing system relative to the first object by calculating a difference between the time of transmission of the first electromagnetic signal and a respective time of receipt of each of the second electromagnetic signals.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques provided herein may be implemented.

FIG. 2 is a diagram showing additional details of a navigation device shown in FIG. 1 and a navigable device that may use the navigation information provided by the navigation device.

FIGS. 3A, 3B, 3C, and 3D are diagrams showing an example vehicle traversing an example environment in which the techniques provided herein may be implemented.

FIGS. 4A, 4B, 4C, and 4D are diagrams of an example tagged object that includes multiple tags that may be interrogated by the navigation device.

FIG. 5 is a diagram showing an example vehicle traversing another example environment in which the techniques provided herein may be implemented.

FIG. 6 is a block diagram of an example tag that may be used to in the example implementation shown in the preceding figures.

FIG. 7 is a flow chart of an example process implemented in a navigation device for navigating a navigable environment.

FIG. 8 is a block diagram showing an example software architecture, various portions of which may be used in conjunction with various hardware architectures herein described, which may implement any of the described features.

FIG. 9 is a block diagram showing components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Techniques are described herein for obtaining navigation information using spread-spectrum signals. The techniques provided herein provide a technical solution to the problem of improved systems and methods that for obtaining information about the environment around autonomous or semi-autonomous vehicles. These techniques may be used by autonomous or semi-autonomous vehicles cars, trucks, buses, or other vehicles for traversing indoor and/or outdoor environments. These techniques may be used to traversing roadways or other substantially two-dimensional environments These techniques may also be used for drones that are capable of traversing three-dimensional environments, such as a building, warehouse, industrial complex, town, city, or other three-dimensional environment. Such drones may be used for pickup or delivery of goods, monitoring the status of one or more features in the environment, capturing surveillance audiovisual content, or other tasks for which the drone may traverse an environment in an autonomous or semi-autonomous manner. The techniques provided herein provide several technical benefits over conventional approaches to navigation that utilize optical analysis and/or LiDAR which may often be impacted by poor ambient lighting conditions and weather conditions by placing multiple radio-frequency identification (RFID) tags on objects within the environment. A navigation system implementing the techniques provided herein instead transmits first transmit electromagnetic signals that activate RFID tags on the object disposed in the environment in which the navigation system is located. The first electromagnetic signals cause the RFID tags to transmit second electromagnetic spread-spectrum signals. The navigation device is configured to receive the second RF spread-spectrum signals and estimate the location of the navigation device relative to the object. The second RF signals may include information identifying the type of object on which the tag is disposed, a unique identifier for the object on which the tag is disposed, geographical coordinate information associated with the location of the object, and/or other information that may be used by the navigation device to determine a location within the environment in which the device is located. The navigation device may generate control signals to control an associated navigable vehicle, which may be an autonomous or semi-autonomous vehicle such as those discussed above. A technical benefit of this approach is that the electromagnetic signals used by the navigation device are not subject to degradation due to poor lighting conditions or adverse weather conditions. Another technical benefit of this approach is that the spread-spectrum signals emitted by the tags on the object reduces the impact of interference caused by signals returned by other tags affixed to the same or other objects. These and other technical benefits of the techniques disclosed herein will be evident from the discussion of the example implementations that follow.

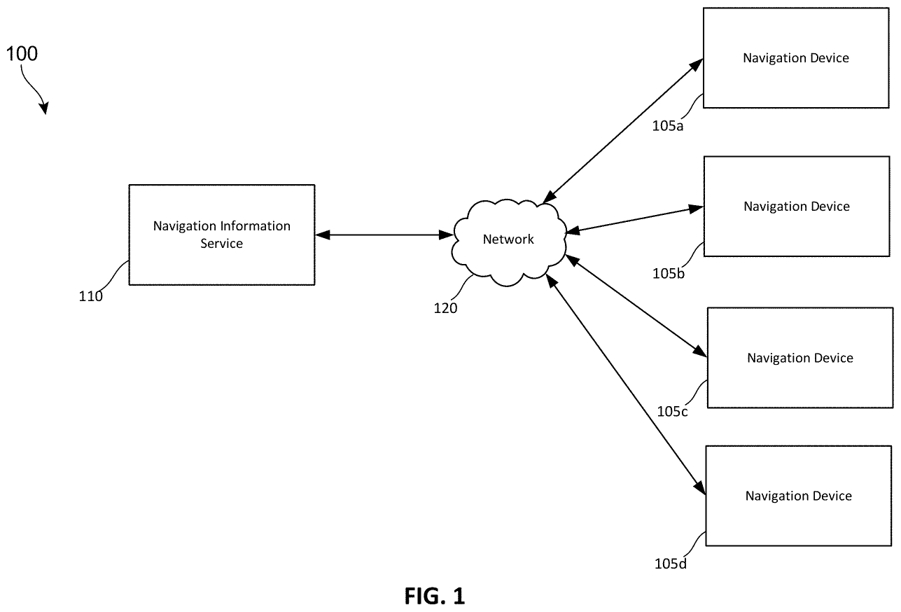

FIG. 1 is a diagram showing an example computing environment 100 in which the techniques disclosed herein for obtaining navigation information using spread-spectrum signals may be implemented. The computing environment 100 may include a navigation information service 110. The example computing environment 100 may also include navigation devices, such as the navigation devices 105a, 105, 105c, and 105d. The computing devices 105a-105d may communicate with the navigation information service 110 via the network 120. The network 120 may include one or more wired and/or wireless public networks, private networks, or a combination thereof. The network 120 may be implemented at least in part by the Internet.

The navigation information service 110 may be configured to provide navigation information that may be used by the navigation devices 105a, 105b, 105c, and 105d for navigating through an environment in which the navigation devices are located. The environment may be an indoor or outdoor environment. The environment may also be substantially two-dimensional, such as but not limited to surface roads over geographic area or a single-story indoor environment. The environment may also be substantially three-dimensional, such as but not limited to a multi-story building, warehouse, industrial complex, town, city, or other three-dimensional space. The navigation information may be used by a navigation device 105 to determine a location of the navigation device 105 in the environment. The navigation information may include route information, such as roads, trail, paths, or other traversable portions of the environment represented by the navigation information. The navigation information may include information identifying the location of objects within the environment that may be used to assist the navigation device in estimating its location and for determining a route through the environment. The objects, as will be discussed in greater detail below, may have one or more RFID tags disposed on the objects such as but not limited to road signs, traffic signals, roadside markers, or other stationary objects in the environment. The tags may be passive tags that are powered by the electromagnetic signals generated by the navigation device 105 interrogating the tags or may be active tags which include a power source. The tags may each be configured to generate a spread-spectrum electromagnetic signal in response to the interrogation signal generated by a navigation device 105. The tag-generated spread-spectrum signal may include information identifying the type of object on which the tag is disposed, a unique identifier for the object on which the tag is disposed, geographical coordinate information associated with the location of the object, and/or other information that may be used by the navigation device to determine a location within the environment in which the device is located. The navigation information provided by the navigation service 110 may include the information provided by each tag so that the navigation device 105 may determine an estimated location of the navigation device 105 relative to the location of one or more of the objects included in navigation information.

In some implementations, the navigation information service 110 may provide the navigation information for a particular area in response to a request from a navigation device 105. For example, the navigation device 105 may request navigation information for a geographical area in which the navigation device 105 is determined to be located. In other implementations, the navigation information service 110 may provide navigation information that may be preloaded into a memory of the navigation device 105 by a manufacturer, seller, or user of the navigation information service 110.

The navigation devices 105a, 105b, 105c, and 105d are each a computing device that may be configured to determine an estimated location of the device within a navigable environment. The navigation devices 105a, 105b, 105c, and 105d may be a standalone device or may be integrated into a navigable vehicle, which may be an autonomous or semi-autonomous vehicle such as cars, trucks, buses, drones, or other vehicles that are configured to receive navigation data. The navigation devices 105a, 105b, 105c, and 105d may be configured to generate command signals to the navigable vehicle to cause the vehicle to steer, brake, accelerate, and/or perform other actions.

The navigation devices 105a, 105b, 105c, and 105d may have a portable form factor that is separate from the navigable vehicle. For example, the navigation devices 105a, 105b, 105c, and 105d each may be a dedicated navigation device, a mobile phone, a tablet computer, a laptop computer, a portable digital assistant device, and/or other such portable computing devices. In other implementations, the navigation devices 105a, 105b, 105c, and 105d may be integrated with the navigable vehicle. For example, the navigation devices 105a, 105b, 105c, and 105d may be a built-in navigation system, entertainment system, or other computer system that is built into the navigable vehicle. While the example implementation illustrated in FIG. 1 includes four navigation devices, other implementations may include a different number of navigation devices. For example, the techniques disclosed herein may be used to provide navigation information to hundreds, thousands, and even millions of navigation devices. Furthermore, the navigation service 110 may be used by combinations of different types of computing devices.

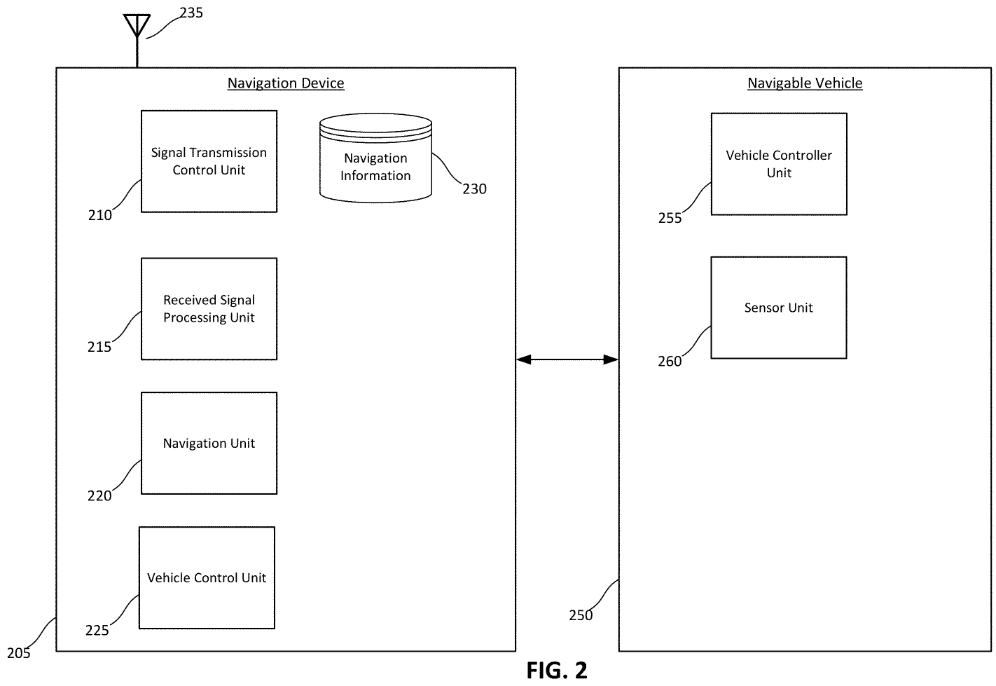

FIG. 2 is a diagram of a navigation device 205 that may be used to implement the navigation devices 105a, 105b, 105c, and 105d shown in FIG. 1. The navigation device 205 may communicate with the navigable vehicle 250. The navigation device 205 may be a portable computing device configured to communicate with the navigable vehicle 250. In other implementations, the navigation device 205 may be integrated with the navigable vehicle and may be part of a built-in navigation system, entertainment system, or other computer system that is built into the navigable vehicle.

The navigation device 205 may include a signal transmission control unit 210, a received signal processing unit 215, a navigation unit 220, a vehicle control unit 225, and an antenna 235. The signal transmission control unit 210 may be configured to control the antenna 235 to transmit a first electromagnetic signal to interrogate RFID tags placed on objects within range of the first electromagnetic signal. The RFID tags may be implemented using RFIDs that have a reading range that extends far enough for the navigation device to be able to read the RFID tags and control the navigable vehicle to respond to the signal received from the RFID tags. Ultra high frequency (UHF) tags may operate in a frequency range of 300 to 1000 MHz and may have a read range of approximately 15 to 20 feet. UHF tags may provide anticollision capability, which allows multiple tags to be read simultaneously. Microwave tags that may operate in a frequency range from 1 to 10 GHz. While the microwave frequency range spans 1 to 10 GHz, microwave tags typically utilize two frequency ranges around 2.4 GHz and 5.8 GHz for RFID application. Passive microwave tags have a read range of up to 100 feet and active microwave tags have a read range of up to 350 feet. Millimeter-wave frequency tags may operate in a frequency range from 30 GHz to 300 GHz and provide an even greater read range.

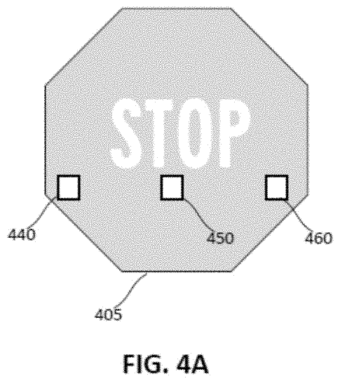

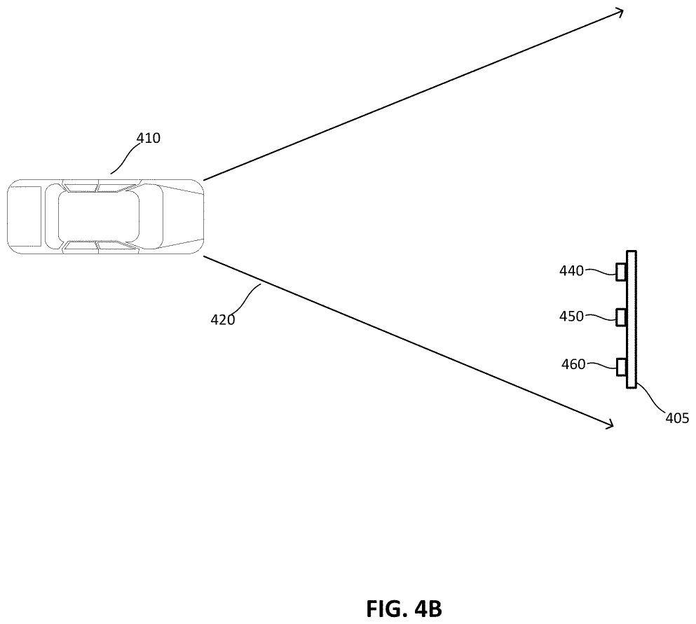

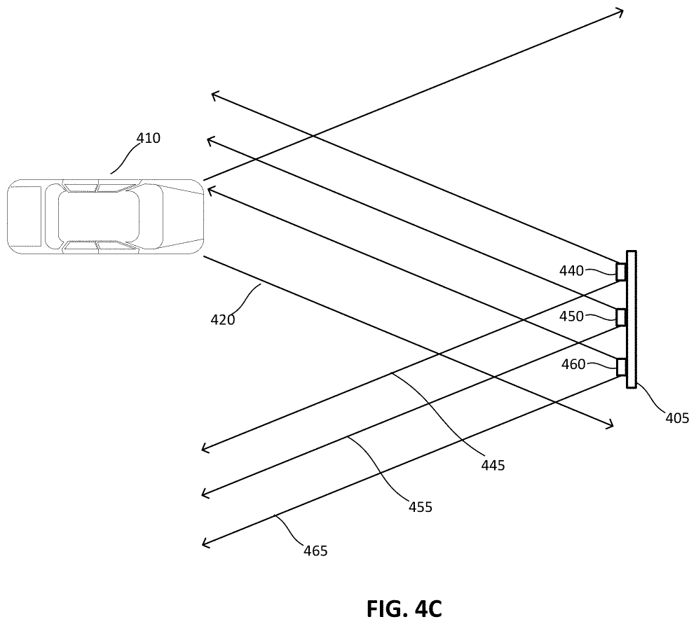

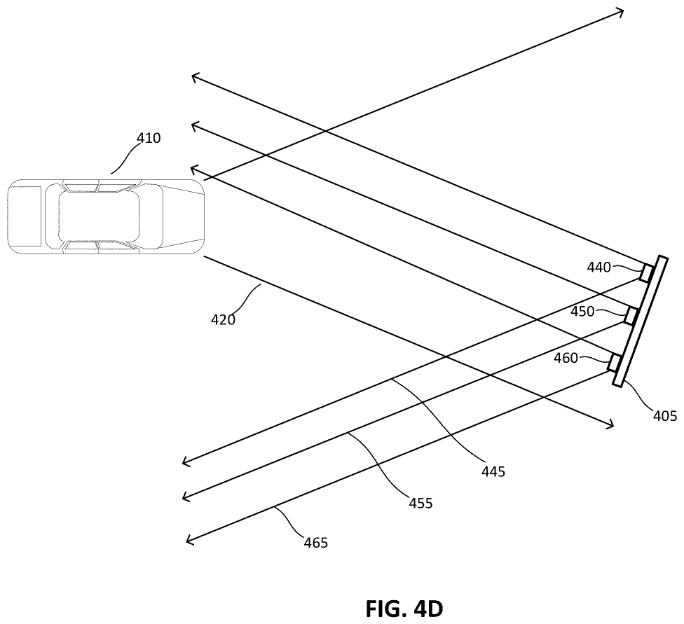

The received signal processing unit 215 may be configured to analyze the spread-spectrum electromagnetic signals transmitted by the RFID tags in response to the interrogation signal transmitted by the navigation device 205. The spread-spectrum RF signals may include information identifying the type of object on which the tag is disposed, a unique identifier for the object on which the tag is disposed, geographical coordinate information associated with the location of the object, and/or other information that may be used by the navigation device to determine a location within the environment in which the device is located. The receiving signal processing unit 215 may include logic for demodulating and/or decoding the spread-spectrum electromagnetic signals transmitted by the RFID tags to obtain the information included therein. The received signal processing unit 215 may also identify phase differences between the electromagnetic signals received from tags associated with the same object. The phase differences may be used to determine an orientation of the object relative to the navigation device 205 as will be discussed with respect to the examples shown in FIGS. 4A-4D.

The navigation unit 220 may be configured to access navigation information for an environment in which the navigation device 205 is located. The navigation unit 220 may be configured to determine a current location of the navigation unit 220 and obtain navigation information for the current location of the navigation unit 220. The current location of the navigation unit 220 may be determined based on signals received one or more satellites of a satellite positioning system (SPS), signals received from one or more Wi-Fi access points, and/or signals received from one or more mobile wireless network base stations. The current location information may be used to obtain navigation information for the environment in which the navigation unit is currently located 220. The navigation information may include information identifying the location of objects within the environment that may be used to assist the navigation device in estimating its location and for determining a route through the environment. The objects, as will be discussed in greater detail below, may have one or more RFID tags disposed on the objects such as but not limited to road signs, traffic signals, roadside markers, wall, buildings, or other stationary objects in the environment. In some implementations, the navigation device 205 may include the navigation information preloaded in memory of the navigation device 205. In other implementations, the navigation unit 220 may be configured to access a Wi-Fi networks and/or mobile wireless networks to request the navigation information from the navigation information service 110.

The navigation unit 220 may use the navigation information and the signal information provided by the received signal processing unit 215 to navigate the navigable vehicle 250 through the navigable environment. The navigation unit 220 may use the navigation information and the signal information received from the RFIDs in several ways. The navigation unit 220 may use the signal information received from the tags on objects in the navigable environment to confirm an estimated location of the navigation unit 220 within the navigable environment. The navigation unit 220 may use signals received from one or more satellites of a satellite positioning system (SPS), signals received from one or more Wi-Fi access points, and/or signals received from one or more mobile wireless network base stations. However, objects within the navigable environment may obstruct or attenuate the signals transmitted by these signal sources, thereby reducing the accuracy of a location of the navigation device 205 based on such signals. However, the navigable environment may include road signs, roadside markers, or other stationary objects that include RFID tags disposed thereon that return an electromagnetic signal that includes the coordinates of the object in response to an interrogation signal by the navigation unit 205.

The navigation unit 220 may use the signals received from the tagged objects to confirm that the location determined using the signals from the one or more satellites of a satellite positioning system (SPS), signals received from one or more Wi-Fi access points, and/or signals received from one or more mobile wireless network base stations is correct by: (1) calculating an estimated distance from the navigation device 205 to one or more tagged objects within the navigable environment using the electromagnetic signals provided by the tags on the objects resulting from the interrogation signal transmitted by the navigation device 205, and (2) determining whether the distances to the one or more tagged objects correspond with expected distances to the one or more tagged objects at the location determined from the one or more satellites of a satellite positioning system (SPS), signals received from one or more Wi-Fi access points, and/or signals received from one or more mobile wireless network base stations.

The navigation unit 220 may also use the signals received from the tags on the tagged objects to assist the semi-autonomous or autonomous navigable vehicle 250 navigating through the navigable environment. For example, a tagged object may provide information such as a speed limit information, the presence of a stop sign, the presence of a sharp curve in the roadway, and/or other information that may be used by the navigation unit 220 to assist the navigation unit 220 in guiding the navigable vehicle 250 through the navigable environment. For example, the presence of a speed limit sign may cause the navigation unit 220 to signal the vehicle control unit 225 to adjust the speed of the navigable vehicle 250 according to the speed limit posted in that area of the navigable environment. The determination of the presence of a stop sign may cause the navigation unit 220 to signal the vehicle control unit 225 to begin braking to prepare the navigable vehicle 250 to stop. Similarly, the presence of a sharp curve in the road may cause the navigation unit 220 to signal the vehicle control unit 225 to reduce the speed of the navigable vehicle 250 and to steer the navigable vehicle through the curve.

The navigation unit 220 may also be configured to navigate through a navigable environment without receiving navigation information for the navigable environment from the navigation information service 110. In such implementations, the navigation unit 220 may rely on information obtained from the tags disposed on objects in the navigable environment to navigate through the navigable environment. For example, the navigation unit 220 may obtain information from tags placed on signage and/or traffic control signals, obstacles, and/or other stationary objects within the navigable environment. The navigation unit 220 may transmit an interrogation signal that causes the tags placed on the objects to transmit a response signal that identifies the object to the navigation system 220. The navigation system 220 may use this information to determine how to navigate the navigable vehicle through the navigable environment. The navigation system 220 may also be configured to obtain sensor information that may assist the navigation system in determining a route through the navigable environment. For example, the navigation system 220 may utilize radar, LiDAR, and/or image processing techniques to supplement the information obtained from the tags disposed on objects throughout the navigable environment.

The vehicle control unit 225 may be configured to generate command signals to the navigable vehicle 250 to cause the vehicle to steer, brake, accelerate, and/or perform other actions. The navigation device may be configured to communicate with the navigable vehicle 250 using a wired or wireless connection. The navigable vehicle 250 may be configured to receive control signals generated by the vehicle control unit 225 and control various aspects of the operation of the navigable vehicle, such as but not limited to steering, braking, accelerating, or other actions.

In some implementations, the navigation unit 220 may be a built-in navigation system, entertainment system, or other computer system that is built into the navigable vehicle. The navigation unit 220 may in communication with control systems of the semi-autonomous or autonomous navigable vehicle 250 via a data bus of the navigable vehicle 250 in such implementations.

The navigable vehicle 250 may include a vehicle controller unit 255 and a sensor unit 260. The vehicle controller unit 255 may receive control signals generated by the vehicle control unit 225 of the navigation device 205, analyze the signals received from the navigation device 205, and send control signals one or more components of the navigable vehicle 250 in response to the control signals received from the navigation device 205. The vehicle controller unit 255 may be configured to obtain sensor information from sensors configured to monitor the state of the vehicle and the navigable environment surrounding the navigable vehicle 250. The vehicle may obtain sensor information from a variety of sensors that monitor the navigable vehicle 250. The sensor information may include accelerometer information indicating changes in velocity of the navigable vehicle 250, gyroscope sensor information indicating an orientation of the navigable vehicle, proximity information from a proximity sensor for detecting objects near the vehicle, temperature information from one or more thermometers monitoring the ambient temperature and/or the temperature of the engine or other components of the navigable vehicle. The vehicle controller unit 255 may be configured to analyze the sensor information to determine whether the vehicle 250 is responding as expected to control signals issue to components of the navigable vehicle 250. The vehicle controller unit 255 may also identify analyze the sensor information to identify situations where the control signals issued by the navigation device 205 cannot be executed safely. For example, the vehicle controller unit 255 may determine that a signal to steer the into a left lane of a roadway cannot be completed safely due to the presence of another vehicle or other object in the roadway. The vehicle controller unit 255 may provide the navigation unit 205 with an indication that a particular control signal cannot be executed safely. The vehicle controller unit 255 receive updated control signals from the navigation device 205 to avoid the other vehicle or object in some implementations. The vehicle controller unit 255 may also be configured to delay the execution of a navigation command received from the navigation device 220 until the navigation command may be safely executed.

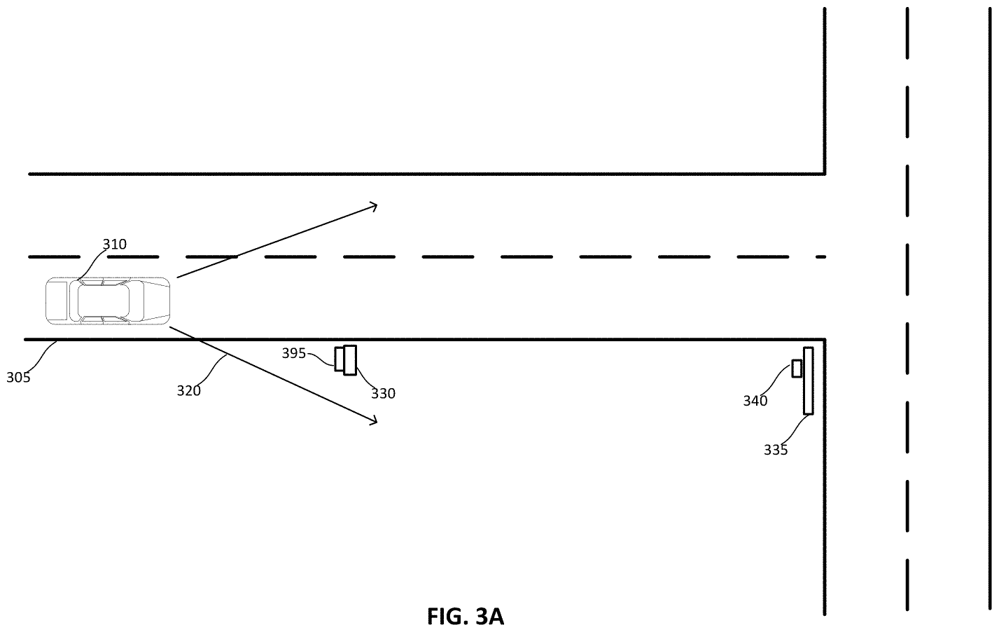

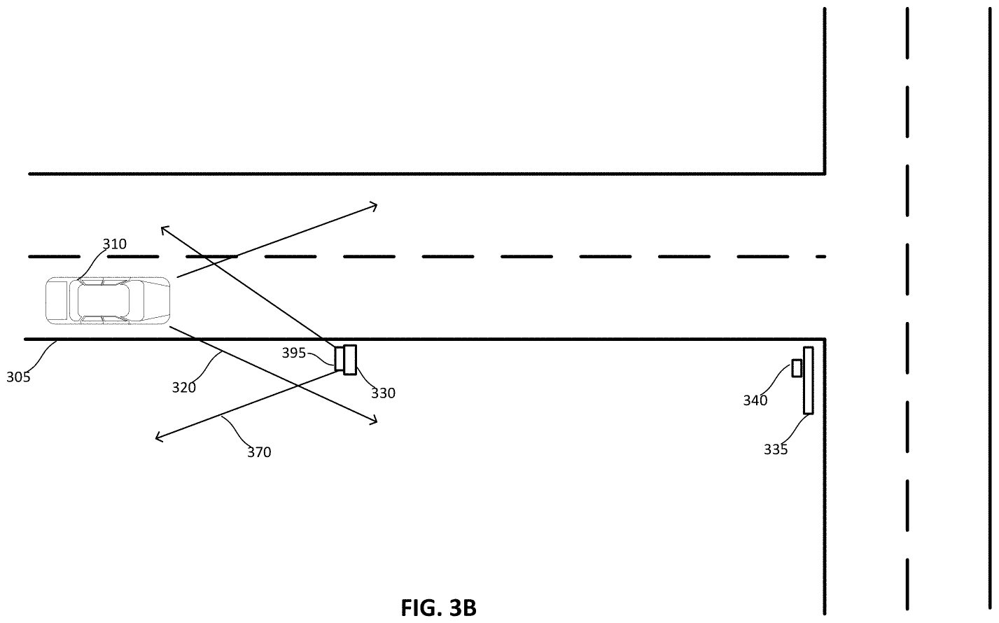

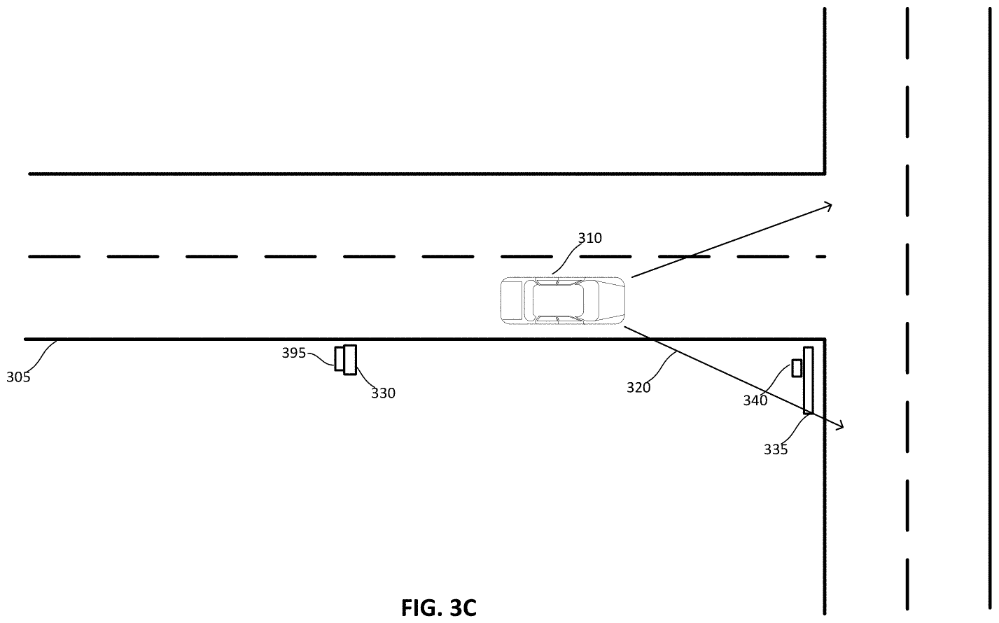

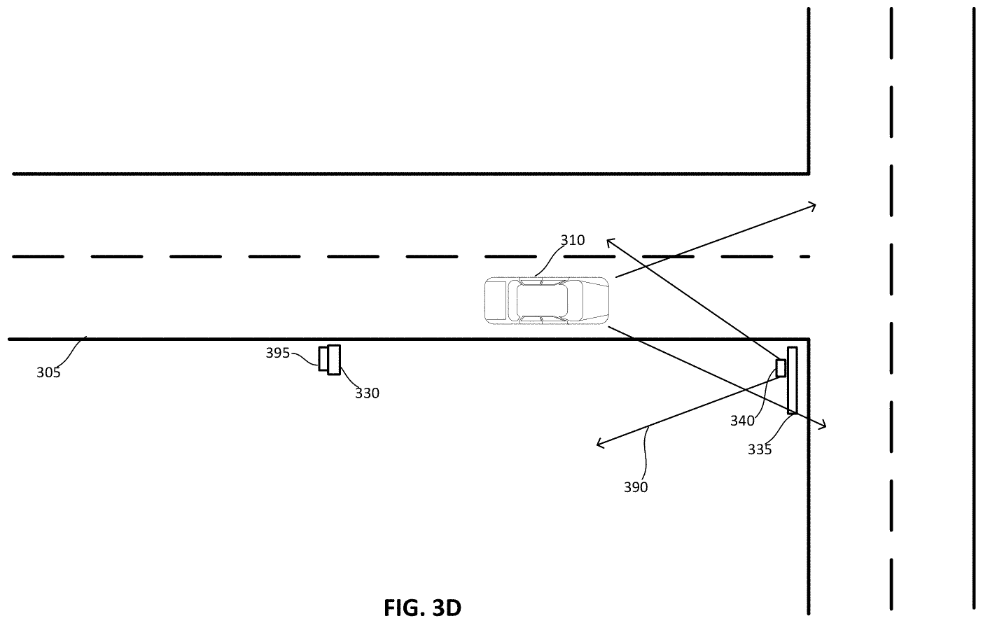

FIG. 3A-3D are diagrams showing an example of a vehicle 310 traversing a navigable environment comprising a roadway 305. The vehicle 310 may be an autonomous or semi-autonomous vehicle, such as the navigable vehicle 250 shown in FIG. 2. The vehicle 310 may also include a navigation device 205 that is configured to control signals that may be used to control one or aspects of the operation of the vehicle 310, such as but not limited to braking, acceleration, and steering. The navigation device 205 may be configured to provide alerts to a driver of the vehicle where the vehicle is being operated in a semi-autonomous mode of operation. In the example shown in FIG. 3A-3D, the vehicle 310 is approaching an intersection with a stop sign 335. A roadside marker 330 is also placed along the roadway 305. The roadside marker 330 and the stop sign 335 may include one or more RFID tags that respond to an interrogation signal 320 generated by the navigation device 205 of the vehicle 310. The first interrogation signal may fall into the UHF, microwave, or millimeter-wave frequency ranges depending upon the implementation. The interrogation signal may be transmitted substantially continually by the navigation device 205 or may be periodically transmitted by the navigation device 205. The roadside marker 330 and the stop sign 335 may include multiple RFID tags that may respond to the interrogation signal 320 of the navigation device 205 of the vehicle 310. However, for clarity, FIGS. 3A-3D show just one RFID tag 340 on the stop sign 335 and one RFID tag 395 on the roadside marker 330. In FIG. 3A, the navigation device 205 has transmitted an interrogation signal 320 but the tag 340 and tag 390 have not yet been activated.

FIG. 3B shows that the tag 390 on the road marker is within range of the interrogation signal 320 of the navigation device 205, and the tag 390 transmits a second electromagnetic signal 370 in response to receiving the interrogation signal 320 of the navigation device 305. The navigation device 205 may receive and analyze the second electromagnetic signal 370. The second electromagnetic signal 370 transmitted by the tag 390 may be a spread-spectrum signal that may include information identifying the type of object on which the tag is disposed, a unique identifier for the object on which the tag is disposed, geographical coordinate information associated with the location of the object, and/or other information that may be used by the navigation device to determine a location within the environment in which the device is located. Thus, the tag 390 may transmit a signal that includes an indication that the tag 390 is disposed on road marker that is specified distance from a stop sign. The indication may provide a unique identifier associated with the road marker which the navigation device 205 may compare with navigation information obtained from the navigation service 110 to obtain an estimated location for the vehicle 310 within the navigable environment and/or to confirm a location of the vehicle 310 within the navigable environment determined by the navigation device 205. Furthermore, the navigation device 205 may use the information included in the tag to determine that the vehicle 310 is approaching the stop sign 335 and will need to stop. The navigation device 205 may send control signals to the vehicle 310 to begin braking and/or decelerating as the vehicle is approaching the stop sign 335.

The navigation device 205 may estimate how far the vehicle 310 is from the stop sign by first estimating how far the vehicle 310 is from the roadside marker 330 and adding the distance from the roadside marker 330 to the stop sign 335 indicated in the response signal received from the tag 395 disposed on the roadside marker 330. Examples of how the navigation device 205 may estimate how far the vehicle 310 is from the roadside marker 330 using time-of-flight information determined by calculating the amount of time that elapsed from the time that the navigation device 205 transmitted the interrogation signal and the response signals from the tag 395 were received by the transceiver of the navigation device 105. FIG. 4, discussed below, provides an example implementation that demonstrates how the distance between the navigation device 205 and a tagged object may be estimated based on the signals exchanged between the navigation device 205 and the tags disposed on the object.

FIG. 3C shows a diagram of the implementation from FIGS. 3A and 3B in which the vehicle 310 has moved further along the roadway 305 toward the stop sign 335. The navigation device 205 of the vehicle 310 transmits the interrogation signal 320 and the tag 340 disposed on the stop sign 335 is within range of the interrogation signal 320. In FIG. 3D, the tag 390 transmits a third electromagnetic signal 390 (a response signal) in response to receiving the interrogation signal 320 of the navigation device 205. The navigation device 205 may receive and analyze the third electromagnetic signal 390. The third electromagnetic signal 390 may also be a spread-spectrum signal that includes information identifying the type of object on which the tag is disposed, a unique identifier for the object on which the tag is disposed (in this example, the stop sign 335), geographical coordinate information associated with the location of the object, and/or other information that may be used by the navigation device to determine a location within the environment in which the device is located. The navigation device 205 may estimate the distance between the vehicle 310 and the stop sign by analyzing the time-of-flight information associated with the interrogation signal 320 transmitted by the navigation device 205 and the time which the response signal 390 is received by the navigation device 205. The navigation device 205 may transmit the interrogation signal 320 multiple times as the vehicle 310 approaches the stop sign 335 causing the tag 340 disposed on the stop sign to transmit the response signal 390 multiple times. The navigation device 205 may use these signals to update the estimated distance between the vehicle 310 and the stop sign 335. The navigation device 205 may also generate control signals to cause the vehicle 3310 to brake and/or decelerate and stop as the vehicle approach the stop sign 335 and to cause the vehicle to stop at the stop sign 335.

FIG. 4A is a diagram showing an example of an object tagged with multiple RFID tags. In the example show in FIG. 4A, a stop sign 405 with three RFID tags 440, 450, and 460 disposed on the stop sign 405. FIG. 4B is a diagram showing a vehicle 410 traveling toward the stop sign 405, and the navigation device 205 of the vehicle 410 emits an interrogation signal 420. FIG. 4C is a diagram showing the tags 440, 450, and 460 receiving the interrogation signal 420. The tag 440 transmits a response signal 445, the tag 450 transmits a response signal 455, and the tag 460 transmits a response signal 465. As discussed in the preceding examples, the response signals transmitted by the tags 440, 450, and 460 may be spread-spectrum signals. Using spread spectrum signals may reduce the impact of interference of response signals on each other.

FIG. 4D shows another example of the stop sign 405 in which the face of the stop sign 405 is oriented at an angle relative to the vehicle 410. In the examples shown in FIGS. 4B and 4C, the face of the sign 405 is substantially perpendicular to the direction of travel of the vehicle 410. Consequently, the interrogation signal 420 transmitted by the navigation device 205 of the vehicle 410 reaches the tags 440, 450, and 460 at substantially the same time, the tags 440, 450, and 460 transmit their respective response signals 445, 455, and 465 at substantially the same time, and the navigation device 205 of the vehicle receives the response signals 445, 455, and 465 at substantially the same time. However, the orientation of the stop sign 405 in FIG. 4D is not substantially perpendicular to the vehicle 410 and the interrogation signal 420 reaches the tags 440, 450, and 460 at slightly different times. The signals reach tag 460 first, the tag 450 second, and the tag 440 third. The tags will then transmit their respective response signals 445, 455, and 465 at slightly different times. As a result of the time delay associated with the response signals 445 and 455, the response signal 455 may have a phase offset relative to the response signal 465 when received at the navigation device 205 of the vehicle 410 because the response signal 455 is transmitted after the response signal 465. Furthermore, the response signal 445 may have a phase offset relative to the response signals 455 and 465 because the response signal 445 is transmitted after the response signals 455 and 465. The navigation device 205 may analyze these phase differences to determine an orientation of the stop sign 405 relative to that of the vehicle 410. The navigation device 205 may use this information to help construct a representation of the topology of the navigable environment proximate to the vehicle 410. The angle of the vehicle relative to a tagged object, such as the stop sign 405 shown in FIGS. 4A-4D may be useful for orienting the vehicle within the navigable environment. This information may be used to generate control signals to cause the vehicle 410 to navigate the vehicle 410 through the navigable environment.

While the examples shown in FIGS. 4A-4D include three tags disposed on the sign in this example. However, other implementations may include a different number of tags. Two or more tags on an object may provide a sufficient number of response signals to calculate an estimated location of the vehicle 410 relative to the stop sign 405. Additional tags placed on the stop sign 405 or other object in the navigable environment may provide more response signals that may be used to increase the accuracy of the estimated position of the vehicle 410 relative to the stop sign 405. The navigation information obtained from the navigation service 110 may include a location of the object in the navigable environment, and a location of the vehicle 410 may be determined by triangulating the position of the vehicle 410 relative to the known location of the tagged object.

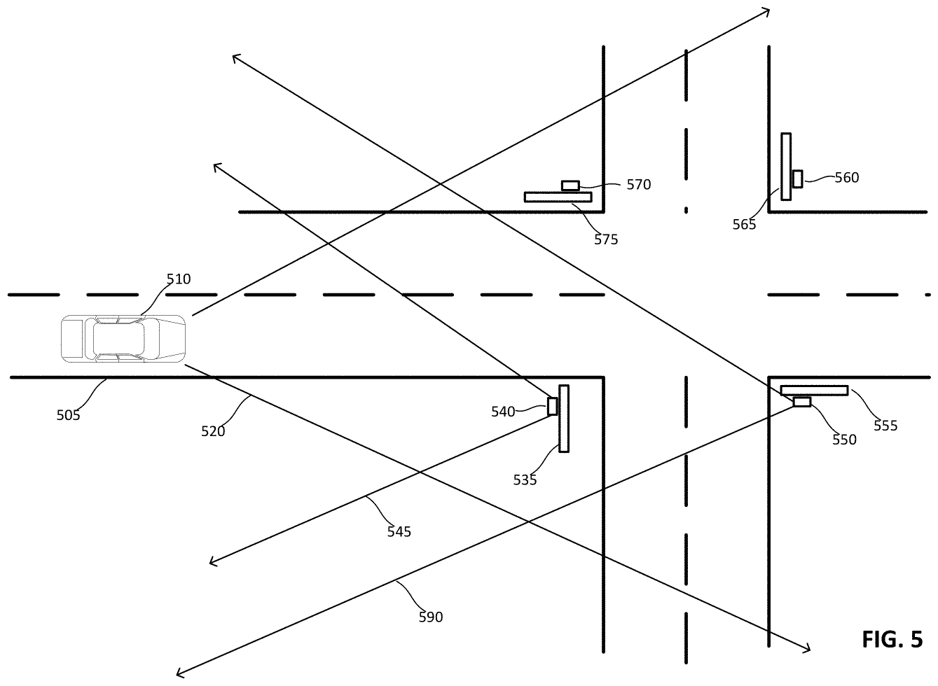

FIG. 5 is a diagram showing another example of a vehicle 505 traversing a navigable environment comprising a roadway 505. The example shown in FIG. 5 demonstrates how the techniques provided herein may be used to determine an estimated topology of the environment through which the vehicle 505 is traversing. The example shown in FIG. 5 includes a roadway 505 that includes a four-way intersection. At each corner of the intersection there is a stop sign and each stop sign includes an RFID tag. In this example, the navigation device 205 of the vehicle 510 emits an interrogation signal 520 which has sufficient range to activate the four RFID tags: tag 540 on stop sign 535, tag 550 on stop sign 555, tag 560 on stop sign 565, and tag 570 on stop sign 575. The tags are oriented on the face of their respective sign. Consequently, the orientation of the signs affects whether the interrogation signal 520 may reach the tag associated with each sign. In this example implementation shown in FIG. 5, the stop sign 535 is oriented such that tag 540 is exposed to the interrogation signal 520, and the stop sign 555 is oriented such that tag 550 is exposed to the interrogation signal 520. However, the metallic body of the stop sign 575 prevents the interrogation signal 520 from reaching the tag 570 and the metallic body of the stop sign 565 prevents the interrogation signal 520 from reaching the tag 560. Thus, the tag 540 generates a response signal 545 and the tag 550 generates a response signal 590. The navigation device 205 of the vehicle 510 may receive the response signals 545 and 590 and analyze these response signals as discussed in the preceding examples.

The signals from each of the tags may be analyzed to obtain information that may be used by the navigation device 205 to identify the type of object on which the tag is disposed, which is a stop sign in this example implementation. The signals may also include a unique identifier associated with the stop sign associated on which the tags are disposed. The signals may also include additional information, such as geographical coordinate information associated with the location of the object, and/or other information that may be used by the navigation device 205 to determine a location within the environment in which the vehicle 510 is located. The navigation device may use this information to determine an estimated topology of the environment based on the estimated location of the vehicle 510 relative to the two devices. In this example, the navigation device 205 may determine that the two tagged objects that returned responses signals to the interrogation signal 520 were stop signs. The positions of the stop signs may be determined by analyzing the time-of-flight information associated with the response signals to determine a relative distance between the vehicle 510 and the stop signs 535 and 550. The navigation device 205 may also determine an angle of arrival for the response signals which may allow the navigation device 205 to further refine the estimated location the stop signs are located relative to the vehicle 510. The navigation device 205 may use this positional information to determine some of the characteristics of the topology of the portion of the navigable environment in which the vehicle 510 is currently located. The detection of the stop signs and their position of the signs relative to one another may indicate that the vehicle 510 is approaching an intersection that includes at least two stop signs. The navigation device 205 may estimate that there may be other features of the topology of the navigable environment that may not have been detected but are common features associated with the type of features detected by the navigation device 205. The navigation device 205 may also obtain other types of sensor information, such as image and/or video data that may be analyzed in addition to the response signals received from the tags disposed on the objects in the environment to further refine the estimated topology of the environment.

The navigation device 205 may use the estimated topology to assist in navigating the vehicle 510 through the navigable environment. The navigation device 205 may generate a sequence of control signals for controlling the operation of the navigable vehicle, such as but not limited to steering, braking, accelerating, or other actions. The estimated topology may also be compared with to map information by the navigation device 205 to confirm an estimated location of the vehicle 510 within the navigable environment by matching object locations in the map information with the estimated topology of determined by the navigation device 205. If the estimated topology does not match the expected topology of the estimated location of the vehicle 501, the navigation device 205 of the vehicle 510 may perform a location determination feature to update estimated the location of the vehicle 510 within the navigable environment.

The navigation device 205 may also be configured to determine a difference between a geographical location of a first tagged object and an estimated location of the navigation device 205 determined by the navigation device. The navigation device 205 may determine that the difference between the two locations exceeds a distance threshold and to perform a location determination procedure responsive to difference exceeding the distance threshold. The first tagged object may be located at a known geographical location. The geographical location of the first tagged object may be provided in the navigation information provided by the navigation service 110 or obtained from the information included in the response signals transmitted by the tags on the tagged object. The navigation device 205 can determine an estimated distance from the first tagged object based on the time-of-flight information associated with the response signal or signals received from tags disposed on the first tagged object responsive to the interrogation signal transmitted by the navigation device 205. The navigation device 205 determine whether the estimated distance from the first tagged object based on the signal information differs from a difference from an estimated distance from the first tagged object based on the estimated location of the navigation device differs by more than the threshold amount. If the difference exceeds the threshold amount, the navigation device may perform a location determination procedure to update the estimated location of the navigation device 205, because the present estimated location of the navigation device 205 appears to be incorrect. The navigation device 205 may use such an approach to verify the estimated location of the navigation device 205 determined by the device matches the actual location of the device within the navigable environment.

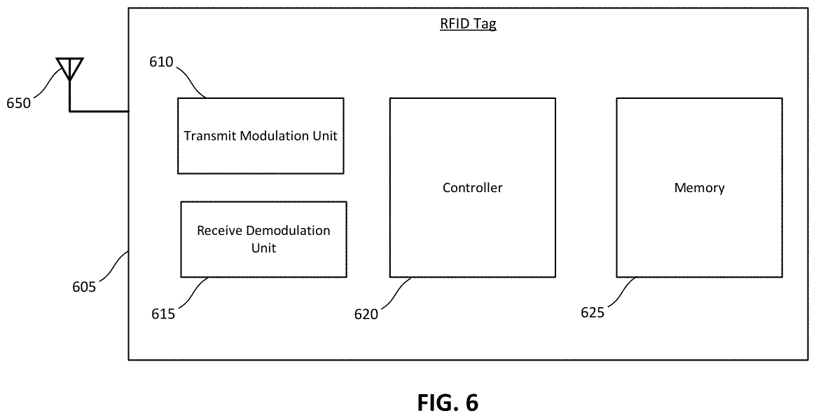

FIG. 6 is a diagram of an example implementation of an RFID tag 605 that may be used to implement the tags disposed on the objects in the preceding examples. The RFID tag 605 includes an antenna 650, a transmit modulation unit 610, a receive demodulation unit 615, a controller 620, and a memory 625. The tag 605 may be a passive RFID tag that is powered by the interrogation signals generated by the navigation device 205. In other implementations, the tag may be an active tag that includes a battery or other power source (not shown). The tag 605 may also be a semi-passive RFID tag that is configured to use the interrogation signals to power the transmission of the response signal by the RFID tag 605 but the controller and other elements of the tag are powered by a battery or other power source.

The RFID tag 605 may be implemented to operate using different frequency ranges which may provide different read ranges. As discussed in the preceding examples, the tag 605 may be implemented to operate in the UHF, microwave, or millimeter wave frequency ranges. The specific frequency range selected may depend upon the type of navigable environment, the types of navigable vehicles traversing the navigable environment, how fast the vehicles may be traversing the environment, and how far away from the tagged objects in the navigable environment that the tags need to be read by the navigation device 205.

The RFID tag 650 may be configured to receive an interrogation signal from the navigation device 205 shown in the preceding examples via the antenna 650. The interrogation signal may be modulated, and the receive demodulation unit 615 may be configured to demodulate the modulated interrogation signal and to provide the demodulated signal to the controller 620. The controller 620 may comprise an electronic circuit or microchip that implements processing logic that may implement the logic of the transmit modulation unit 610 and/or the receive demodulation unit 615. The controller 620 may also be configured to read and/or write data to the memory 625. The controller 620 may also be configured to decode digital bits in the interrogation signal received from the navigation device 205 and/or to encode digital bits in the response signal to be transmitted in response to the interrogation signal. The controller 620 may also be configured to provide power control for the tag 605.

The memory 625 may be a read-only memory, a write-once memory, or write-many times. The memory may be divided into blocks or banks of memory, and each bank of memory may be read-only memory, a write-once memory, or write-many times memory. The tags may use electrically erasable, programmable, read-only memory (EEPROM) which does not require power to retain the contents of the memory. The memory may be used to store various types of information, such as information identifying the type of object on which the tag is disposed, a unique identifier for the object on which the tag is disposed, geographical coordinate information associated with the location of the object, and/or other information that may be used by the navigation device to determine a location within the environment in which the device is located. Some implementations may tags having a write-once memory so that the tag information for a particular object on which the tag or tags are disposed may be updated with information associated with the object but cannot be updated once the tags have been programmed. This approach may be used to prevent unauthorized modifications or tampering with the RFID tag data deployed on objects in a navigable environment. Multiple tags may be placed on an object and the tags may be programmed with the same information.

The tag 605 may be configured such that the tag generates a spread-spectrum response signal in response to an interrogation signal by the navigation device 425. A spread-spectrum signal may be used to reduce the impact of interference on the response signals generated by the tag 605. This approach may be particularly useful where there are large number of tags deployed in a navigable environment and/or where there are multiple tags disposed on a tagged object within the navigable environment. Placing multiple tags on an object in the navigable environment may provide multiple response signals that the navigation device 205 may use to determine an estimated location of the navigation device 205 relative to the tagged object. Such an implementation was shown in FIG. 4. The example implementation shown in FIG. 6 is one possible configured for RFID tags that may be used with the techniques provided herein. Tags having other configurations may also be used.

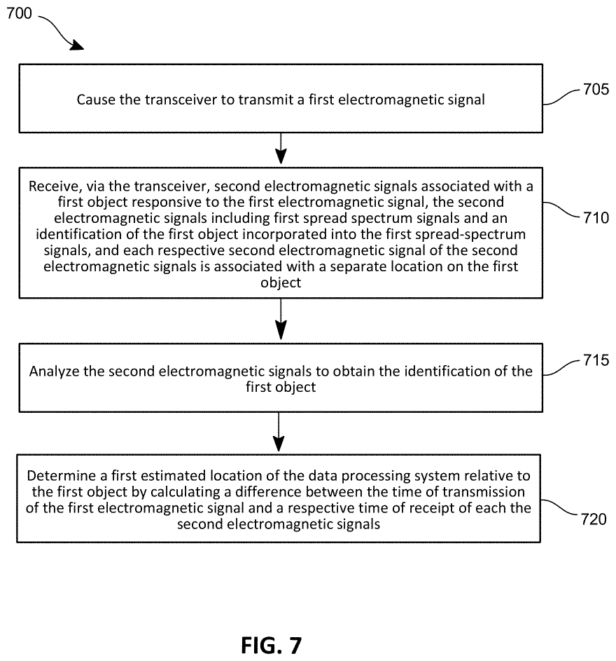

FIG. 7 is a flow chart of an example process 700 for testing performance of software product versions. The process 700 may be implemented by a navigation device, such as the navigation devices 105a, 105b, 105c, and 105d discussed in the preceding examples.

The process 700 may include an operation 705 of causing the transceiver to transmit a first electromagnetic signal. The navigation device may transmit an interrogation signal to cause the tags disposed on objects in the environment in which the navigation device is located to respond with a modulated electromagnetic signal.

The process 700 may include an operation 710 of receiving, via the transceiver, second electromagnetic signals associated with a first object responsive to the first electromagnetic signal. The second electromagnetic signals including first spread-spectrum signals and an identification of the first object incorporated into the first spread-spectrum signals, each respective second electromagnetic signal of the second electromagnetic signals being transmitted from a separate location on the first object. As discussed in the preceding examples, the multiple RFID tags may be disposed on an object in the environment being navigated. The object may be sign, traffic signal, roadside marker, or another stationary object in the environment. The RFID tags may be passive or active tags and may be configured to transmit the second electromagnetic signals in response to the

The process 700 may include an operation 715 of analyzing the second electromagnetic signals to obtain the identification of the first object. The second RF signals may include information identifying the type of object on which the tag is disposed, a unique identifier for the object on which the tag is disposed, geographical coordinate information associated with the location of the object, and/or other information that may be used by the navigation device to determine a location within the environment in which the device is located. The signal second electromagnetic signals may be demodulated by the transceiver and the identification of the first object may be extracted.

The process 700 may include an operation 720 of determining a first estimated location of the data processing system relative to the first object by calculating a difference between the time of transmission of the first electromagnetic signal and a respective time of receipt of each of the second electromagnetic signals. The navigation device 105 may be configured to use time-of-flight information to determine an estimated location of the navigation device 105 relative to the object. The time-of-flight information may be determined by calculating the amount of time that elapsed from the time that the first electromagnetic signals were transmitted, and the second electromagnetic signals were received by the transceiver of the navigation device 105.

The detailed examples of systems, devices, and techniques described in connection with FIGS. 1-7 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-7 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

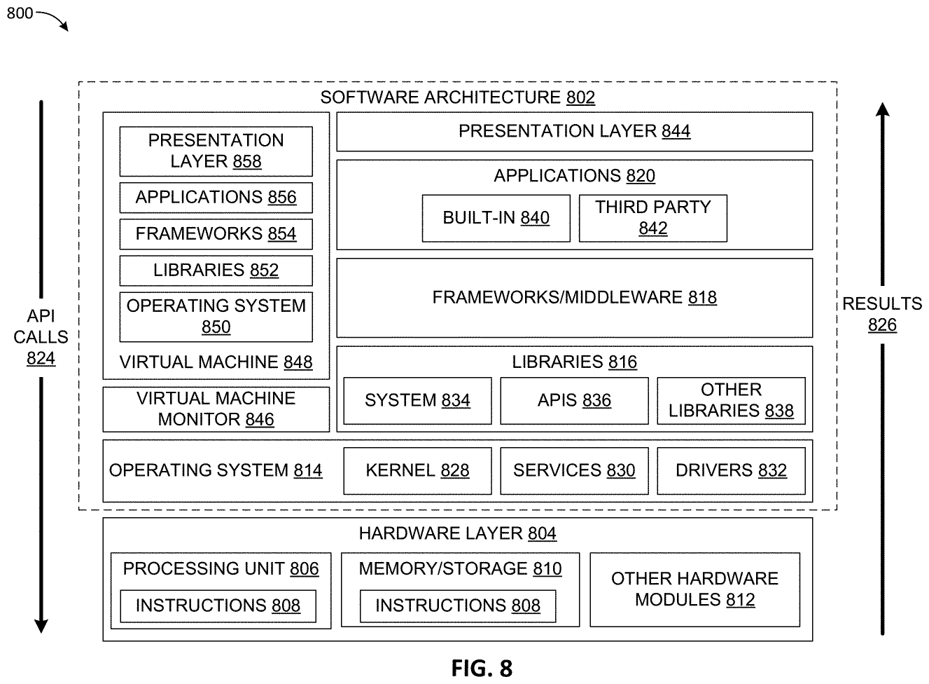

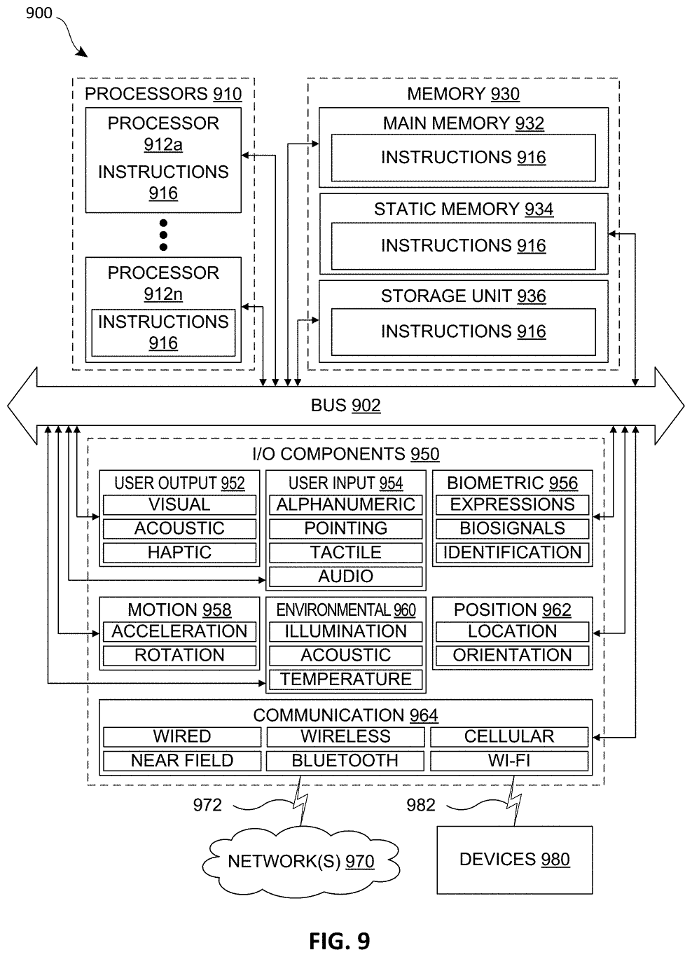

FIG. 8 is a block diagram 800 illustrating an example software architecture 802, various portions of which may be used in conjunction with various hardware architectures herein described, which may implement any of the above-described features. FIG. 8 is a non-limiting example of a software architecture and it will be appreciated that many other architectures may be implemented to facilitate the functionality described herein. The software architecture 802 may execute on hardware such as a machine 900 of FIG. 9 that includes, among other things, processors 910, memory 930, and input/output (I/O) components 950. A representative hardware layer 804 is illustrated and can represent, for example, the machine 900 of FIG. 9. The representative hardware layer 804 includes a processing unit 806 and associated executable instructions 808. The executable instructions 808 represent executable instructions of the software architecture 802, including implementation of the methods, modules and so forth described herein. The hardware layer 804 also includes a memory/storage 810, which also includes the executable instructions 808 and accompanying data. The hardware layer 804 may also include other hardware modules 812. Instructions 808 held by processing unit 806 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks 818, applications 820, and a presentation layer 844. Operationally, the applications 820 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks 818 (also sometimes referred to as middleware) provide a higher-level common infrastructure that may be used by the applications 820 and/or other software modules. For example, the frameworks 818 may provide various graphic user interface (GUI) functions, high-level resource management, or high-level location services. The frameworks 818 may provide a broad spectrum of other APIs for applications 820 and/or other software modules.

The applications 820 include built-in applications 840 and/or third-party applications 842. Examples of built-in applications 840 may include, but are not limited to, a contacts application, a browser application, a location application, a media application, a messaging application, and/or a game application. Third-party applications 842 may include any applications developed by an entity other than the vendor of the particular platform. The applications 820 may use functions available via OS 814, libraries 816, frameworks 818, and presentation layer 844 to create user interfaces to interact with users.

Some software architectures use virtual machines, as illustrated by a virtual machine 848. The virtual machine 848 provides an execution environment where applications/modules can execute as if they were executing on a hardware machine (such as the machine 900 of FIG. 9, for example). The virtual machine 848 may be hosted by a host OS (for example, OS 814) or hypervisor, and may have a virtual machine monitor 846 which manages operation of the virtual machine 848 and interoperation with the host operating system. A software architecture, which may be different from software architecture 802 outside of the virtual machine, executes within the virtual machine 848 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement modules or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (GPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multi-core processor including cores that may execute instructions contemporaneously. Although FIG. 9 shows multiple processors, the machine 900 may include a single processor with a single core, a single processor with multiple cores (for example, a multi-core processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “machine-readable medium” refers to a device able to temporarily or permanently store instructions and data that cause machine 900 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956, motion components 958, environmental components 960, and/or position components 962, among a wide array of other physical sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 958 may include, for example, acceleration sensors (for example, an accelerometer) and rotation sensors (for example, a gyroscope). The environmental components 960 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 964 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 962, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
an antenna;
a transceiver coupled to the antenna and configured to send and receive electromagnetic signals via the antenna; and
a controller communicably coupled with the transceiver, the controller including a processor and a computer-readable storage medium storing executable instructions that, when executed, cause the processor to perform operations of:
causing the transceiver to transmit a first electromagnetic signal;
receiving, via the transceiver, second electromagnetic signals associated with a first object responsive to the first electromagnetic signal, the second electromagnetic signals including first spread-spectrum signals and an identification of the first object incorporated into the first spread-spectrum signals, each respective second electromagnetic signal of the second electromagnetic signals being transmitted from a separate location on the first object;
analyzing the second electromagnetic signals to obtain the identification of the first object; and
determining a first estimated location of the data processing system relative to the first object by calculating a difference between the time of transmission of the first electromagnetic signal and a respective time of receipt of each of the second electromagnetic signals.

2. The data processing system of claim 1, wherein the computer-readable storage medium includes instructions configured to cause the processor to perform:
receiving, via the transceiver, third electromagnetic signals associated with a second object responsive to transmitting the first electromagnetic signal, the third signals comprising second spread-spectrum signals, the third electromagnetic signals including an identification of the second object, each respective third electromagnetic signal of the third electromagnetic signals being associated with a separate location on the third object;
analyzing the third electromagnetic signals to obtain the identification of the second object;
determining a second estimated location of the data processing system relative to the second object by calculating a difference between the time of transmission of the first electromagnetic signal and a respective time of receipt of each the third electromagnetic signals; and
determining an estimated topology of an environment in which the first object, the second object, and the data processing system are disposed based on the first estimated location and the second estimated location.

3. The data processing system of claim 1, wherein, to determine a first estimated location of the data processing system relative to the first object based on the second electromagnetic signals associated with the first object, the computer-readable storage medium includes instructions configured to cause the processor to perform:
detecting a phase shift in the plurality of second electromagnetic signals; and
determining an orientation of the data processing system relative to the first object based on the phase shift in the plurality of second electromagnetic signals.

4. The data processing system of claim 1, wherein the computer-readable storage medium includes instructions configured to cause the processor to perform:
causing the transceiver to transmit a third electromagnetic signal prior to transmitting the first electromagnetic signal;
receiving, via the transceiver, fourth electromagnetic signals associated with a second object responsive to transmitting the third electronic signal, the fourth electromagnetic signals including an indication that the second object is disposed a predetermined distance from the first object;
analyzing the fourth electromagnetic signals to obtain the indication that the second object is disposed a predetermined distance from the first object;
determining that the data processing system is disposed at least the predetermined distance from the first object; and
performing one or more actions in response to the determination that the data processing system is disposed at least the predetermined distance from the first object.

5. The data processing system of claim 4, wherein the first object and the second object are infrastructure road signs, traffic signals, lane markers, or a combination thereof disposed along a roadway, and wherein to perform the one or more actions the computer-readable storage medium includes instructions configured to cause the processor to perform:
generating a control signal for a vehicle to control the operation of the vehicle; and
sending the control signal to the vehicle.

6. The data processing system of claim 1, wherein the second electromagnetic signals further comprise an indication of a first geographical location of the first object, the computer-readable storage medium including instructions configured to cause the processor to perform:
determining a first difference between the first geographical location of the first object and a second estimated location of the data processing system determined by the data processing system;
determining that the first difference exceeds a distance threshold; and
performing a location determination procedure for the data processing system responsive to the second estimated location of the data processing system exceeding the distance threshold.

7. The data processing system of claim 1, wherein the second electromagnetic signals are generated by a first plurality of radio-frequency identification (RFID) tags disposed on a first object responsive to the first electromagnetic signal activating the first plurality of RFID tags.

8. A method implemented in a data processing system, the method comprising:
causing a transceiver associated with the data processing system to transmit a first electromagnetic signal;
receiving, via the transceiver, second electromagnetic signals associated with a first object responsive to the first electromagnetic signal, the second electromagnetic signals including first spread-spectrum signals and an identification of the first object incorporated into the first spread-spectrum signals, each respective second electromagnetic signal of the second electromagnetic signals being transmitted from a separate location on the first object;
analyzing the second electromagnetic signals to obtain the identification of the first object; and
determining a first estimated location of the data processing system relative to the first object by calculating a difference between the time of transmission of the first electromagnetic signal and a respective time of receipt of each of the second electromagnetic signals.

9. The method of claim 8, further comprising:
receiving, via the transceiver, third electromagnetic signals associated with a second object responsive to transmitting the first electromagnetic signal, the third signals comprising second spread-spectrum signals, the third electromagnetic signals including an identification of the second object, and each respective third electromagnetic signal of the third electromagnetic signals is associated with a separate location on the third object;
analyzing the third electromagnetic signals to obtain the identification of the second object;
determining a second estimated location of the data processing system relative to the second object by calculating a difference between the time of transmission of the first electromagnetic signal and a respective time of receipt of each the third electromagnetic signals; and
determining an estimated topology of an environment in which the first object, the second object, and the data processing system are disposed based on the first estimated location and the second estimated location.

10. The method of claim 8, wherein determining a first estimated location of the data processing system relative to the first object based on the second electromagnetic signals associated with the first object further comprises:
detecting a phase shift in the plurality of second electromagnetic signals; and
determining an orientation of the data processing system relative to the first object based on the phase shift in the plurality of second electromagnetic signals.

11. The method of claim 8, further comprising:
causing the transceiver to transmit a third electromagnetic signal prior to transmitting the first electromagnetic signal;
receiving, via the transceiver, fourth electromagnetic signals associated with a second object responsive to transmitting the third electronic signal, the fourth electromagnetic signals including an indication that the second object is disposed a predetermined distance from the first object;
analyzing the fourth electromagnetic signals to obtain the indication that the second object is disposed a predetermined distance from the first object;
determining that the data processing system is disposed at least the predetermined distance from the first object; and
performing one or more actions in response to the determination that the data processing system is disposed at least the predetermined distance from the first object.

12. The method of claim 11, wherein the first object and the second object are infrastructure road signs, traffic signals, lane markers, or a combination thereof disposed along a roadway, and wherein performing the one or more actions further comprises:
generating a control signal for a vehicle to control the operation of the vehicle; and
sending the control signal to the vehicle.

13. The method of claim 8, wherein the second electromagnetic signals further comprise an indication of a first geographical location of the first object, the method further comprising:
determining a first difference between the first geographical location of the first object and a second estimated location of the data processing system determined by the data processing system;
determining that the first difference exceeds a distance threshold; and
performing a location determination procedure for the data processing system responsive to the second estimated location of the data processing system exceeding the distance threshold.

14. The method of claim 8, wherein the second electromagnetic signals are generated by a first plurality of radio-frequency identification (RFID) tags disposed on a first object responsive to the first electromagnetic signal activating the first plurality of RFID tags.

15. A computer-readable storage medium on which are stored instructions that, when executed, cause a processor of a programmable device to perform operations of:
causing a transceiver associated with the data processing system to transmit a first electromagnetic signal;
receiving, via the transceiver, second electromagnetic signals associated with a first object responsive to the first electromagnetic signal, the second electromagnetic signals including first spread-spectrum signals and an identification of the first object incorporated into the first spread-spectrum signals, each respective second electromagnetic signal of the second electromagnetic signals being transmitted from a separate location on the first object;
analyzing the second electromagnetic signals to obtain the identification of the first object; and
determining a first estimated location of the data processing system relative to the first object by calculating a difference between the time of transmission of the first electromagnetic signal and a respective time of receipt of each of the second electromagnetic signals.

16. The computer-readable storage medium of claim 15, wherein the computer-readable storage medium includes instructions configured to cause the processor to perform:
receiving, via the transceiver, third electromagnetic signals associated with a second object responsive to transmitting the first electromagnetic signal, the third signals comprising second spread-spectrum signals, the third electromagnetic signals including an identification of the second object, and each respective third electromagnetic signal of the third electromagnetic signals is associated with a separate location on the third object;
analyzing the third electromagnetic signals to obtain the identification of the second object;
determining a second estimated location of the data processing system relative to the second object by calculating a difference between the time of transmission of the first electromagnetic signal and a respective time of receipt of each the third electromagnetic signals; and
determining an estimated topology of an environment in which the first object, the second object, and the data processing system are disposed based on the first estimated location and the second estimated location.

17. The computer-readable storage medium of claim 15, wherein, to determine a first estimated location of the data processing system relative to the first object based on the second electromagnetic signals associated with the first object, the computer-readable storage medium includes instructions configured to cause the processor to perform:
detecting a phase shift in the plurality of second electromagnetic signals; and
determining an orientation of the data processing system relative to the first object based on the phase shift in the plurality of second electromagnetic signals.

18. The computer-readable storage medium of claim 15, wherein the computer-readable storage medium includes instructions configured to cause the processor to perform:
causing the transceiver to transmit a third electromagnetic signal prior to transmitting the first electromagnetic signal;
receiving, via the transceiver, fourth electromagnetic signals associated with a second object responsive to transmitting the third electronic signal, the fourth electromagnetic signals including an indication that the second object is disposed a predetermined distance from the first object;
analyzing the fourth electromagnetic signals to obtain the indication that the second object is disposed a predetermined distance from the first object;
determining that the data processing system is disposed at least the predetermined distance from the first object; and
performing one or more actions in response to the determination that the data processing system is disposed at least the predetermined distance from the first object.

19. The data processing system of claim 18, wherein the first object and the second object are infrastructure road signs, traffic signals, lane markers, or a combination thereof disposed along a roadway, and wherein to perform the one or more actions the computer-readable storage medium includes instructions configured to cause the processor to perform:
generating a control signal for a vehicle to control the operation of the vehicle; and
sending the control signal to the vehicle.

20. The computer-readable storage medium of claim 15, location wherein the second electromagnetic signals further comprise an indication of a first geographical location of the first object, the computer-readable storage medium including instructions configured to cause the processor to perform:
determining a first difference between the first geographical location of the first object and a second estimated location of the data processing system determined by the data processing system;
determining that the first difference exceeds a distance threshold; and
performing a location determination procedure for the data processing system responsive to the second estimated location of the data processing system exceeding the distance threshold.
